(19) United States
(12) Patent Application Publication
(10) Pub. No.: US 2006/0188676 A1
(43) Pub. Date: Aug. 24, 2006

(54) Flexible tube made from polypropylene and method for production of said tube

(76) Inventor: Gery Bernard Marie Cornil Dambricourt, Escoutoux (FR)

Correspondence Address: BACHMAN & LAPOINTE, P.C., 900 CHAPEL STREET, SUITE 1201, NEW HAVEN, CT, 06510, US

(21) Appl. No.: 10/543,077

(22) PCT Filed: Jan. 14, 2004
(86) PCT No.: PCT/FR04/00063

§ 371 Date: Dec. 16, 2005

(30) Foreign Application Priority Data
Jan. 24, 2003 (FR) 03/00819

(51) Int. Cl. B32B 27/32

(52) U.S. Cl. 428/35.2

(57) ABSTRACT

A flexible tube comprising a skirt and a distribution head, resistant to cracking under stress and forming a barrier to water. The wall of the tube is made from at least one first polymer from the group of polypropylenes, with, at the mid-point from the end of the skirt furthest from the head to the end of the neck forming the distribution hole of the tube, a thickness of between 0.30 mm and 1.00 mm, with a section modulus of between 700 MPa and 80 MPa, the section moduli of the components of the wall being chosen to follow a law of maximum dispersion. The tube finds application in the storage of all products, in particular pasty bodies in cosmetics and pharmaceuticals.

### BACKGROUND OF THE INVENTION

(1) Field of the Invention

The invention generally pertains to a flexible tube resistant to stress-cracking and forming a water vapour barrier, and a method for fabricating said tube.

More precisely, the invention, according to a first characteristic, concerns a tube resistant to stress-cracking and forming a water barrier, essentially consisting of a flexible skirt elongate along an axial direction and a head comprising at least one evacuation orifice and a neck forming a radial extension of the orifice and being joined to the skirt in an axial direction, at least the skirt and neck forming a single piece assembly, the tube wall consisting of a mixture of a number “n” at least equal to 1 of polymers belonging to the family of copolymers-olefins prepared from C₂ to C₁₀ monomers.

In the preceding generic definition, the term “mixture” is to be construed in the broadest meaning and encompasses a material consisting of a single polymer, said material possibly being considered at all times as formed of a mixture of any complementary fractions of this same polymer.

(2) Prior Art

Paste products, such as toothpaste, pharmaceutical products, cosmetic products, food products, hygiene products, fats and greasy substances, putty and glue are often proposed in packaging of flexible tube type. These tubes consist of a tubular body of constant cross-section of circular, oval or other shape. The tubular body forming what is called hereunder the “skirt” has a first end generally closed by heat sealing and a second opposite end, configured so as to form a dispensing head for the product contained in the skirt. The dispensing head is provided with screw-on, snap-fit or other capping means of so-called “standard” cap type, so-called “service” cap type or other.

As a general rule, heat sealing of the first end of the tube is made after filling the tube with the paste product to be packaged.

The capacity of the tube is one of its essential characteristics. In the particular case of a tube with constant circular cross-section, the capacity is defined by the length and diameter of the skirt, i.e. by the length and diameter of the circular cross-section of the skirt.

To extract the product from the tube, the consumer presses on the tube wall which undergoes deformation and creasing that are increasingly pronounced as and when the tube is emptied.

The tube skirt must therefore be made in a flexible material. This material must be heat sealable. It must also have characteristics of resistance to stress-cracking, imperviousness to water vapour and no yellowing in time under the effect of the products contained in the tube or through so-called “cross” contamination i.e. attributable to contamination agents external to the tube, in order to meet specifications regarding the compatibility of the products intended to be packaged in the tube.

Tubes meeting all these criteria are most often fabricated by assembly or insert moulding of the dispensing head made by injection and of the skirt made by extrusion. Another method, called injection blow moulding, that is little used and costly, consists of forming the skirt by moving the impression of a mould consecutively to injection of the head in this mould. Finally, the skirt and the dispensing head may be made by injection, in a single operation.

The fabrication of the tube using the injection method offers numerous advantages: this method replaces a succession of operations by a single operation; it chiefly allows great freedom of shape and eliminates the welding between the neck and skirt of the tube which is a rigid zone, hence a factor of discomfort for the user.

A first polymer used for fabricating flexible tubes with the injection method is polyethylene.

The first difficulty encountered when fabricating a flexible tube using the injection method derives from the strong correlation between resistance to stress-cracking and the viscosity of the polymer when a polyethylene is used.

Stress-cracking is a phenomenon of physicochemical attack of a surfactant product on a polymer. This phenomenon translates as the formation of micro-cracks in the polymer possibly going as far as bursting of the wall. The risk of bursting is particularly high in the vicinity of the heat-sealed end.

The products contained in the tube contain a greater or less extent of surfactants and may therefore cause wall cracking or bursting.

To characterize the resistance of the material to stress-cracking, the tubes are tested in the following manner.

The tube is filled with a 0.3% surfactant solution, IGEPAL CO 630 for example or ETHOXYL NONYLPHENOL in distilled water, and sealed at one end by heat welding. The tube is placed in an oven at 55° C. for 24 hours. When removed from the oven a pressure of 2 bars to 4.5 bars is applied to the tube for 2 to 10 seconds, in accordance with the specifications of the order giver. When taken from the oven, the tube must not show any leak at the heat-seal and no cracking or tearing of the wall.

The polyethylenes which meet the specifications for stress-cracking are highly viscous.

To inject these highly viscous polymers, manufacturers are led to increasing the thickness of the tube wall.

Table 1 below describes the relationship between the required injection pressure and the thickness of the tube wall when the injected material is a polyethylene whose melt flow index (MFI) is 5 g/10 mn according to standard ISO 1133, and for two tube examples:
firstly a tube 19 mm in diameter, of skirt length 56 mm for a capacity of between 5 and 9 ml, and

secondly, a tube 35 mm in diameter, of skirt length 125 mm and a capacity of 75 ml.

TABLE 1

| | | | Injection |
|---|---|---|---|
| TUBE FORMAT | | Wall thickness | pressure |
| 5/9 | ml | 0.45 | 2500 bars |
| | | 0.52 | 2000 bars |
| | | 0.60 | 1500 bars |
| 75 | ml | 0.60 | 3200 bars |
| | | | impossible |
| | | 0.70 | 2700 bars |
| | | | impossible |
| | | 0.80 | 2100 bars |

Taking as assumption a polymer of grade 5, a tube of capacity 75 ml and a skirt length of 125 mm, when the wall thicknesses are 0.6 and 0.7 mm the injection pressures to be used are inaccessible. According to chosen pressure, either the result is destruction of the material through exceeding the limit shear rate, or non-filling of the mould the material solidifying over its pathway, or destruction of the material through overstepping the limit temperature.

As a general rule, polyethylene is therefore better suited for tubes of small or medium size, so as to limit the wall thickness imposed by the high viscosity of the material.

The use of a propylene-based mixture makes it possible to overcome this issue since in general polypropylenes have both a relatively high melt flow index and acceptable resistance to stress-cracking, including when the melt flow index is relatively high. The mixture can therefore be easily injected on account of its melt flow.

The main obstacle to the use of polypropylene arises from its rigidity, in general much higher than that of polyethylene, which in principle should limit its use for the fabrication of flexible tubes.

Correlatively, polypropylenes have crease memory, whiten on creasing and have a pungent smell that is hardly acceptable when they are too rigid.

The second obstacle arises from the lower water-barrier property of polypropylene, that is generally lower than that of the polyethylenes commonly used to fabricate the skirt of flexible tubes.

International patent application WO 01/68355 describes a flexible tube obtained with the injection method and the wall consists of a polyethylene or a mixture of polyethylenes. Although the obtained tube is able to conform to specifications under certain conditions, the use of said polymer leads to limit situations in which the tube wall has excessive rigidity or low imperviousness, but also to situations in which the tube cannot be injected.

European patent EP 0 856 473 describes a packaging, a tube in particular, made with the injection method and whose wall consists of a mixture of a propylene homopolymer and a copolymer of propylene and ethylene.

This solution, restrictive in the proposed choices, defines neither the rigidity nor the water-barrier characteristics of the tube wall, whereas the essential problem raised by the use of polypropylene arises through the contradiction between these two constraints.

Document EP 0 856 473 does not approach the difficulties of industrialisation either related to the use of the proposed materials.

### SUMMARY OF THE INVENTION

Within this context, the invention sets out in particular to propose a tube whose wall is both flexible and develops an effective water barrier effect.

For this purpose, the tube of the invention, conforming to the generic definition given in the preamble above, is essentially characterized:
in that, at its mid-length along the axial direction, from the skirt end distant from the head as far as the end of the neck forming the evacuation orifice, it has a wall thickness of between 0.30 and 1.00 mm,
in that at least one polymer of the mixture belongs to the polypropylene family,
in that the constituent mixture of the tube wall has a flexural modulus of between 700 MPa and 80 MPa, preferably between 500 MPa and 120 MPa according to standard NF EN ISO 178, and
and in that each polymer having a flexural modulus defined according to standard NF EN ISO 178 and being conventionally assigned a rank “i” which, in a classification of the “n” polymers of the mixture in decreasing order of their respective flexural modulus values μᵢ, places this polymer between a first polymer (i=1) of maximum rigidity and a last polymer (i=n) of minimum rigidity, and each polymer being contained in the mixture in a weight percentage xᵢ with respect to the total weight of the mixture, the mixture has a dispersion factor Kd of the flexural modulus values of no more than 3 or 2.2 according to whether or not it contains a polyethylene, preferably no more than 2 in both these cases, and further preferably no more than 1.5, this dispersion factor Kd being defined as:

$$Kd = {\sum }_{i = 1}^{n} [ ( ( {\sum }_{j = 1}^{i - 1} {x}_{j} ) \cdot {( {ν}_{1 , i - 1} - {ν}_{1 , i} )}^{2} + {x}_{i} \cdot {( {λ}_{i} - {ν}_{1 , i} )}^{2} ) / {ν}_{1 , i}^{2} ] ,$$
in which:
   λᵢ=MAX(μᵢ, 1500 MPa),
and in which:

$${ν}_{p , q} = ( {\sum }_{i = p}^{q} {x}_{i} \cdot {λ}_{i} ) / ( {\sum }_{i = p}^{q} {x}_{i} ) .$$

The above equations are to be interpreted as implicitly using the writing convention expressed by the relationship:

$$∀ Z , s < r ⇒ ( {\sum }_{r}^{s} Z ) = 0.$$

The first polymer may be a copolymer of propylene and ethylene.

In particular, the first polymer is a heterophase polypropylene copolymer of propylene and ethylene.

The most rigid polymer may advantageously have a flexural modulus of no more than 850 MPa, the result being that the constituent mixture of the tube wall has a strong water barrier.

The first polymer may also have a flexural modulus of no more than 500 MPa.

For example, the mixture comprises at least one second polymer.

In this case, the second polymer preferably has a flexural modulus that is greater than 70 MPa, and is contained in the mixture to a proportion of between 15% and 85%, preferably between 25% and 75%.

The second polymer may also have a flexural modulus of less than 70 MPa and be contained in the mixture to a proportion of less than 50%, preferably of between 15% and 40%.

The second polymer may consist of a linear C₄-C₁₀ copolymer of ethylene-olefin, this second polymer having a melt flow index (MFI) measured according to standard ISO 1133 of between 3 g/10 mn and 15 g/10 mn, preferably of between 4 g/10 mn and 12 g/10 mn.

In particular, the second polymer may consist of a copolymer of ethylene-octene.

Nonetheless, the second polymer may also be a polypropylene or a heterophase copolymer of propylene and ethylene.

The first polymer, which may optionally be the only polymer used, advantageously has a flexural modulus of less than 250 MPa for a tube capacity of at least 30 ml.

It may generally be of advantage that any polymer of the polypropylene family contained in the composition of the constituent mixture of the wall has a melt flow index (MFI) measured according to standard ISO 1133 of no more than 100 g/10 mn, preferably of no more than 20 g/10 mn.

The length of a tube according to the invention may lie between 40 and 85 mm, or between 85 and 200 mm.

The tube of the invention may typically be obtained by injection into an injection mould comprising a core and an impression, the core itself comprising a central part of which one free end centre-bears upon the impression at least during the injection phase of the tube skirt.

The free end of the central part of the core advantageously comprises supply channels, in which case the tube, at its injection end, has an apex wall formed at least in part of sectors corresponding to the supply channels.

In this case, the accumulated widths of the sectors, in the zones where they join the face parallel to the axial direction of the orifice, advantageously represent 15%, preferably more than 25%, of the face perimeter.

Each of these sectors may have an increasing width which increases from an injection point of the mould along a centrifugal radial direction as far as the points where the sectors join with the face of the orifice.

Also, the wall of the orifice preferably has an annular throttle zone located beyond the sectors.

The wall of the orifice may optionally be extended by a ring of material positioned in a plane perpendicular to the axis, underneath the end of the neck.

Preferably, the central part of the core of the injection mould is mobile, and the apex wall of the tube end is formed without any gaps after drawing backwardly the mobile central part over a distance corresponding to the desired thickness of this apex wall.

The free end of the central part of the core may be in the shape of a sunken cone, the angle γ formed by the bearing surface of this free end on the impression with the plane perpendicular to the longitudinal axis of the tube then lying between 15° and 45°, or even between 15° and 20°.

The free end of the central part of the core may also be in the shape of a projecting cone frustum, the angle □ formed by the bearing surface of the projecting frustum of this free end on the impression and by the plane perpendicular to the longitudinal axis of the tube then lying between 35° and 45°.

The free end of the central part of the core may further be in the shape of a sunken cone in its part internal to the projecting cone frustum, the angle δ formed by the bearing surface of the sunken cone of this free end on the impression with the plane perpendicular to the longitudinal axis of the tube being less than 45°, and preferably between 15° and 20°.

The head comprises single-piece securing means for example of nozzle type and a single-piece reducer, the nozzle and reducer being positioned in the continuation of the orifice along axis XX′, the apex wall of the nozzle forming the reducer, the orifice of the reducer being obtained by cutting after forming the tube by injection, the tube, nozzle and reducer thereby forming a single-piece assembly formed by injection in a single operation.

Preferably, the wall of the single-piece nozzle carries an asymmetric thread.

Also it is possible to provide that the tube of the invention is equipped with capping means provided with a conical tip, that the tip enters into the orifice of the single-piece reducer, and that the tip places the reducer wall under centrifugal radial tension in the vicinity of the opening orifice.

The head may comprise single-piece securing means of nozzle type positioned in the continuation of the orifice along axis XX′, the tube and the securing means forming a single-piece assembly formed by injection in a single operation.

The tube may be equipped with an added accessory of dispensing-means type of added reducer type or added nozzle tip, or securing means of added nozzle type forming a reducer or nozzle tip, or capping means of service cap type, the added accessory being positioned in the continuation of the orifice along axis XX′.

The added accessory may be equipped with a chimney of which an outer face is conjugated with the face parallel to axis XX′ of the orifice, after inserting the chimney inside the orifice.

In this case, it is advantageous for the chimney of the added accessory to place the side wall of the orifice under centrifugal radial tension.

If the added accessory is non-removable, the chimney of the added accessory is fitted for example with a penetration device of conical shape, the outer face of the chimney being radially recessed with respect to the penetration device.

The invention also concerns a method for fabricating a flexible tube formed of a skirt and a head comprising at least one evacuation orifice and a neck forming a radial extension of the orifice and joined to the skirt, at least the skirt and neck forming a single-piece assembly, resistant to stress-cracking and forming a water barrier, this method being characterized in that it comprises the steps consisting of:
using as constituent material of the wall a mixture of a number “n” at least equal to 1 of polymers belonging to the family of copolymers-olefins prepared from C₂ to C₁₀ monomers, at least one polymer belonging to the polypropylene family, the constituent mixture of the wall having a flexural modulus of between 700 MPa and 80 MPa, preferably between 500 and 120 MPa according to standard NF EN ISO 178, and of
fabricating the skirt and head of the tube by injecting the mixture in a single injection operation into an injection mould comprising an impression and a core, said core comprising a central part of which a free upper end centre-bears upon the impression at least during the injection of the skirt.

### BRIEF DESCRIPTION OF THE DRAWINGS

Other characteristics and advantages of the invention will become more readily apparent on reading the following description, given for illustrative purposes and in no way limitative, with reference to the appended drawings in which:

FIGS. 1 and 2 show a front view of first and second examples of the tube of the invention, as seen after sealing the filling end.

FIGS. 3A, 3B, 3C and 3D are four cross-sections of the tube head shown FIG. 1, according to four different embodiments.

FIG. 4 shows a prior art mould used for fabricating a tube by injection.

FIG. 5 shows a mould which can be used for the injection of the tube of the invention.

FIG. 6 schematically shows the injection flows during injection of the tube of the invention.

FIG. 7 is an enlarged, perspective view of the part denoted VII in FIG. 5.

FIG. 8 schematically shows a perspective view of the mould head to be used for injecting the tube of the invention according to a first embodiment.

FIG. 9 is a cross-sectional view of the tube head and corresponding zone of the mould, fabricated according to a first embodiment of the tube, and obtained during the injection phase of the tube skirt, along axis IX-IX in FIG. 8.

FIG. 9A is a cross-sectional view of the tube head and corresponding zone of the mould, fabricated according to another embodiment and as seen during the injection phase of the tube skirt along the same axis IX-IX.

FIG. 10 is an overhead view of the apex wall of the tube when the mould core is in centre bearing on the impression of this mould.

FIGS. 11A, 11B, 11C and 11D are four cross-sectional views showing four examples of assembly with an added accessory, the tube head conforming to the embodiments shown FIGS. 3A, 3B, 3C and 3D, the neck being shown in accordance with the first and second examples of the tube of the invention.

### DETAILED DESCRIPTION OF THE PREFERRED EMBODIMENT(S)

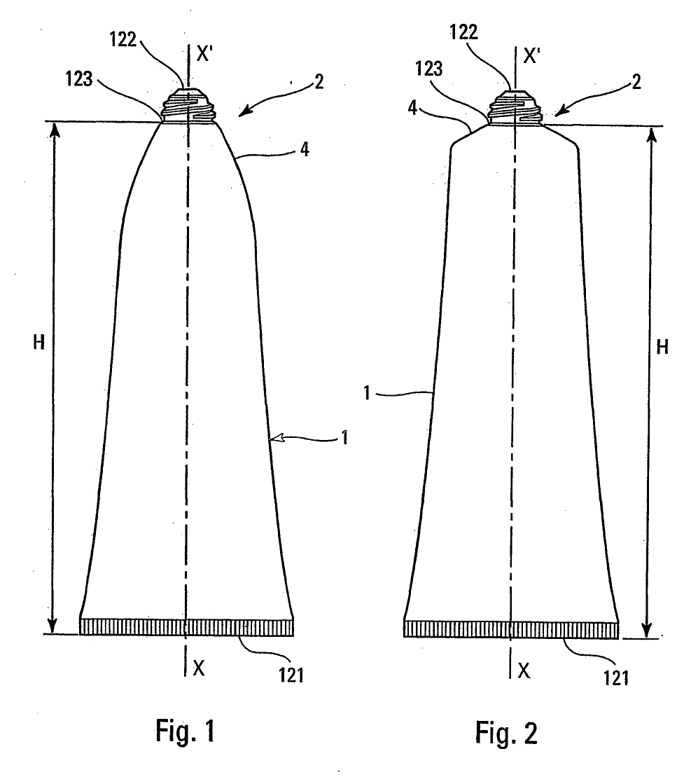

As mentioned previously, the invention concerns a tube essentially consisting of a flexible skirt 1 elongate along an axial direction XX′, and of a head 2 comprising at least one evacuation orifice 3 and a neck 4 forming a radial extension of the orifice and being joined to the skirt 1 along the axial direction XX′, at least the skirt and neck forming a single-piece assembly as shown FIGS. 1, 2, 3A, 3B, 3C and 3D.

The capacities of the tubes usually proposed on the market lie between 2 and 500 ml. Their skirt length to diameter ratios, as usually found on the market, are between 2, 5 and 6 and are preferably close to 4.

The invention preferably applies to formats in force on the market, and therefore pays heed to a ratio of skirt length to diameter of between 2, 5 and 6, preferably close to 4.

Depending upon tube capacity and depending upon the skirt length/tube diameter ratio, the length of the skirt therefore lies between 40 and 200 mm.

Also, the products contained in the flexible envelope have a greater or lesser water content.

At the current time, in cosmetology in particular, packaged products show a trend towards water-based emulsions. The packaging of these products must therefore meet increasingly severe criteria of imperviousness to water vapour in order to avoid excessive weight loss through evaporation of water through the flexible wall of which the consequence would be a change in the “paste” nature of the cream packaged in the tube. As water permeability is always measured as a weight loss percentage of the cream through evaporation, with respect to the initial weight of the cream contained in the tube, weight loss is therefore expressed in the form of a ratio which simultaneously depends upon the water porosity of the wall and the ratio between the evaporation surface, i.e. the skirt surface, and the volume of cream contained in the tube.

The water imperviousness test consists of placing the tubes, previously filled with the product to be tested and then sealed, in an oven having a temperature, depending upon tests, of between 40° and 55° C., generally between 45 and 50° C. for a period of time, according to test, of between 1 week and 16 weeks, most frequently between 2 and 8 weeks.

Depending upon type of cream, tube size, the volume of cream contained in the tube, the barrier effect required by specifications, oven exposure time and oven temperature, the weight loss must be less than 2%, 3%, 5% or 8% for least constraint cases.

For example, a weight loss of 5% for a quantity of cream of 5 grams represents an evaporation of 0.25 grams of water. This is therefore an extremely restricting test when considering packaging in a tube of diameter 19 mm and oven exposure of the tube at 45° C. for 8 weeks.

Generally, the test is more difficult the smaller the size of the tube: the smaller the capacity of the tube, the greater the ratio between the evaporation surface, formed by the skirt, and the contained volume of cream.

For the same reason, the difficulty of the test increases when the tube is only partly filled, which also contributes to increasing the ratio between the evaporation surface and the volume of cream contained in the tube.

To conclude, weight loss is related firstly to the characterization of the actual material, i.e. its porosity, and secondly to a set of characteristics concerning the relationship between the content (the cream) and the container (the tube).

These characteristics are:
the targeted weight loss which varies considerably depending on whether the client gives priority to wall flexibility or the water vapour barrier effect,
the volume of cream effectively packaged in the tube,
the evaporation surface represented by the skirt surface,
wall thickness,
weight loss test conditions, i.e. the number of days of oven exposure, and oven temperature, and
the components of the cream contained in the tube.

Finally, the tube skirt must be flexible to allow evacuation of the paste products contained therein, by mere user pressure on the wall.

Polypropylenes are polymers whose flexural modulus values are most often higher than the flexural modulus values of the polyethylenes generally used for fabricating tubes by injection, and vary in substantial proportions between 60 MPa and 2000 MPa, even 2500 MPa, according to standard ISO 178, in relation to their chemical structure and in particular to the quantity of copolymerised ethylene in the polymer.

Since wall porosity is directly related to its flexural modulus, tubes whose wall offers a sufficient water barrier are too rigid, and flexible tubes are both insufficiently impervious to water and difficult to inject.

When the tube is made in a material consisting of polymers of which at least one is a polypropylene, this material must therefore be characterized by a sufficiently high flexural modulus to define an imperviousness that is compatible with the desired weight loss, and sufficiently low to obtain a wall whose flexibility conforms to the use of the tube, flexibility being related simultaneously to the thickness of the wall and to the flexural modulus of its constituent material.

Whenever possible, it is generally preferable to use a single polymer when the wall material is polypropylene-based.

Nonetheless, the use of a single material assumes that the flexural modulus of the polymer used corresponds exactly to the targeted flexibility and weight loss, it also being necessary for the chosen polypropylene to be injectable in the flow pathway defined by the thickness and length of the tube wall.

It is therefore more frequently necessary to have recourse to mixtures of polymers to obtain the desired result.

The analyses performed on mixtures made and tested lead to the following observations:

Firstly, the variation in weight loss of products packaged in tubes is not linear with the variation in the flexural modulus of the wall, the flexural modulus decreasing more rapidly than the deterioration in weight loss of the products contained in the tube, when the flexural modulus of the polypropylene is high, greater than the acceptable maximum flexural modulus. More particularly, it was found that over and above 1500 MPa, the increase in the flexural modulus of the polymer no longer has any notable influence on the observed weight loss.

Secondly, weight loss increases very rapidly when the flexural modulus of the most flexible polymer is very low and when this polymer is simultaneously used in a high percentage especially of more than 50%.

As a result, it is preferable to achieve a targeted flexibility provided by mixtures that are the most homogenous possible.

In other words:
the flexural modulus of the most rigid polymer must be as low as possible,
the flexural modulus of the most flexible polymer must be as high as possible, and
the percentages of the different constituent polymers of the mixture must be as balanced as possible, the flexural modulus of a mixture always being lower than the mean flexural modulus values of the polymers forming the mixture when this mixture has a balanced content of its different constituents.

Consideration of the phenomena previously mentioned and the observation of numerous mixtures have led to imagining a law with which it is possible to optimise the compromise to be made between the need to reduce weight loss and the need to impart flexibility to the tube allowing its easy, pleasant use.

More precisely, consideration is given, in fully generic manner, to mixtures of “n” polymers in which “n” is an integer which, for reasons of simplicity, is at least equal to 1, the term “mixture” for value “n=1” being fully warranted since a material consisting of single polymer is at all events comparable to a mixture of complementary fractions of this same polymer, each polymer belonging to the family of olefin copolymers prepared from C₂ to C₁₀ monomers.

At mid-distance of length H of the tube along its axial direction XX′ from end 121 of the skirt distant from the head, as far as end 123 of the neck 4 forming the evacuation orifice 3, the wall has a thickness of between 0.30 and 1.00 mm.

At least one polymer of the mixture belongs to the polypropylene family, the mixture having a flexural modulus of between 700 MPa and 80 MPa, preferably between 500 and 120 MPa according to standard NF EN ISO 178.

By convention, polymers are classified in the mixture in decreasing order of rigidity, each polymer thereby assuming a rank denoted “i” which equals 1 for the first polymer, by definition the most rigid, and equals “n” for the last polymer, by definition the least rigid.

Also, each polymer of rank “i” is contained in the mixture in a weight percentage xᵢ of the total weight of the mixture, and has a flexural modulus defined according to standard NF EN ISO 178, and whose value forms a measurement of the rigidity of this polymer.

The above-mentioned law has recourse to a parameter or “dispersion factor” denoted Kd, related to the flexural modulus values of the different polymers in the mixture, and defined by:

$$Kd = {\sum }_{i = 1}^{n} [ ( ( {\sum }_{j = 1}^{i - 1} {x}_{j} ) \cdot {( {ν}_{1 , i - 1} - {ν}_{1 , i} )}^{2} + {x}_{i} \cdot {( {λ}_{i} - {ν}_{1 , i} )}^{2} ) / {ν}_{1 , i}^{2} ] ,$$

in which:
λᵢ=MAX(μᵢ, 1500 MPa),

and in which:

$${ν}_{p , q} = ( {\sum }_{i = p}^{q} {x}_{i} \cdot {λ}_{i} ) / ( {\sum }_{i = p}^{q} {x}_{i} ) .$$

As will be easily understood by persons skilled in the art, “MAX” designates the function of maximum selection and the symbol “sigma” designates a summation operator, the latter meeting the writing convention expressed by the relationship:

$$∀ Z , s < r ⇒ ( {\sum }_{r}^{s} Z ) = 0.$$

According to an essential characteristic of the invention, the dispersion factor Kd of the mixture is no more than 3 or 2.2 depending on whether or not the mixture contains a polyethylene, preferably no more than 2 in both cases, and further advantageously no more than 1.5.

The invention is therefore able to define a range of materials whose flexural modulus enables the precise adaptation of the characteristics of flexibility and imperviousness to the desired use, and in particular to targeted weight loss, tube size, its content and the shape of the head.

With the invention, it is possible, for all objectives of flexural modulus, to simultaneously define the composition of the mixture which minimizes weight loss.

It was also found that the flexural behaviour of polyethylene (PE) and of polypropylene (PP) are of different type. While comfort of use of the tube is strictly proportional to the flexural modulus of the wall of this tube for a given chemical nature of this wall, this does not apply if tubes are compared whose walls are made using the PP/PP option (i.e. in which the first and second polymers are polypropylenes), using the PP/PE option (i.e. in which the first polymer is a polypropylene and the second polymer is a polyethylene), or using the PE/PE option (i.e. in which the first and second polymers are polyethylenes).

Care must therefore be taken when comparing the flexural modulus of two materials whose PE and PP compositions are different.

Finally, when PE is used as simple additive to PP, resistance to stress-cracking of the PP/PE mixture conforming to specifications may be obtained with much more fluid PEs than when using the PE/PE option, for example with polyethylenes whose melt flow index (MFI) is no more than 15 g/10 mn, preferably no more than 12 g/10 mn, i.e. between 3 g/10 mn and 15 g/10 mn, preferably between 4 g/10 mn and 12 g/10 mn.

Table 2 illustrates the results regarding flexibility and permeability of the tubes fabricated using the injection method and whose base material contains at least a first polymer from the polypropylene family. The results are given for three first polymers of different polypropylenes, among which two are associated with a second polymer.

Results regarding tube flexibility are illustrated by the value of the flexural modulus. Permeability results are relative values with respect to a reference 100 which represents the weight loss of a strong barrier tube i.e. conforming to weight loss specifications for a tube of diameter 19 mm, skirt length 56 mm before sealing, in which a 5 ml volume of cream has been packaged.

This base 100 approximately corresponds to a weight loss of less than 2% for a tube placed in an oven at 50° for 14 days, or less than 5% for a tube placed in an oven at 45° for 56 days.

TABLE 2

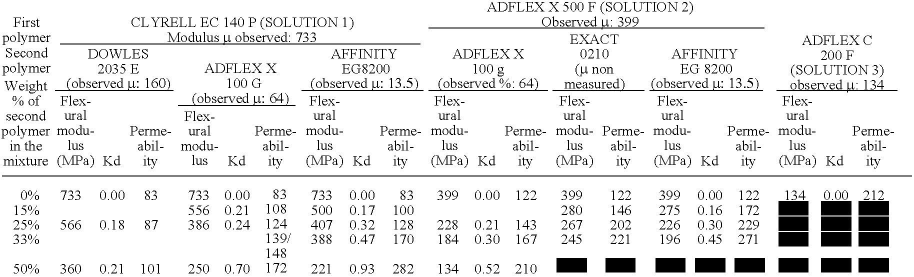

*Flexural modulus: modulus measured according to standard NF EN ISO 178. This modulus may differ from the modulus given in the sales documents of the polymer manufacturers, for low or very low modulus values.

Annex to Table 2

First polymers:
CLYRELL EC 140 P: heterophase copolymer of propylene and ethylene, having an indicated flexural modulus* of 740 MPa according to standard ISO 178, a melt flow index of 16 g/10 mn and marketed by BASELL;
ADFLEX X 500 F: heterophase copolymer of propylene and ethylene, having an indicated flexural modulus 470 MPa according to standard ISO 178, a melt flow index of 7.5 g/10 mn, a density of 0.89 g/cm³ and marketed by BASELL;
ADFLEX C 200 F: heterophase copolymer of propylene and ethylene, having an indicated flexural modulus of 220 MPa according to standard ISO 178, a melt flow index of 6 g/10 mn, a density of 0.890 g/cm³ and marketed by BASELL;

Second polymers:
DOXLEX 2035E: linear copolymer of ethylene-octene, having a flexural modulus of 240 MPa according to standard ASTM D638, a melt flow index of 6 g/10 mn, a density of 0.919 g/cm³ and marketed by DOW;
ADFLEX X 100 G: heterophase copolymer of propylene and ethylene, having an indicated flexural modulus of 80 MPa, a melt flow index of 8 g/10 mn, a density of 0.890 g/cm³, and marketed by BASELL;
AFFINITY EG 8200: linear copolymer of ethylene-olefin, having an indicated flexural modulus of 20 MPa according to standard ASTM D790, a melt flow index of 5 g/10 mn, a density of 0.870 g/cm³ and marketed by DOW;
EXACT 0210: linear copolymer of ethylene-octene, having a flexural modulus of 65 MPa according to standard ISO 178, a melt flow index of 10 g/10 mn, a density of 0.902 g/cm³, and marketed by DEXPLASTOMERS;
The “indicated” flexural modulus is the one given in the supplier's documents. The flexural modulus reproduced in Table 2 is the modulus measured in accordance with standard NF EN ISO 178.
The viscosity index is given in g/10 mn in accordance with standard ISO 1133.

Table 2 shows the choices of possible materials in relation to tube size and the desired objectives.

It is to be noted firstly that the measured flexural modulus values shown in the document and the calculated permeability indexes lie within the sphere of desired objectives for maximum weight losses in relation to tube capacity and desired wall flexibility.

It is also to be noted beforehand, that for all examined solutions the relationship was ascertained between the increase in wall flexibility and the increase in weight loss attributable to wall porosity.

The following prior observations must also be made:
while softness to the touch is strictly in reverse proportion to the flexural modulus inside each column (same components), comparisons between tubes consisting of mixtures belonging to different columns in Table 2 (different components) and all the more so comparisons between walls consisting of polyethylene only and walls consisting of polypropylene only must be made with caution, in particular when the flexural modulus values are low. Two tubes consisting of materials showing differences in the flexural modulus in the order of 50 MPa, even 100 MPa may have comparable softness to touch.

The weight losses mentioned in Table 2 are given for guidance purposes for a given cream, a given tube and given conditions of weight loss measurement (oven temperature and study period).

Consequently, the present invention defines the ranges of characterisation which guarantee ranges of results in terms of flexibility and weight loss.

Within these ranges, any result obtained must be validated by a final test which will take into account the actual product packaged, the actual tube used and contractual conditions (specifications) for the weight loss test.

The first polymer used belongs to the family of polypropylenes and is preferably a copolymer of ethylene and propylene.

When the most rigid polypropylene belongs to the family of copolymers of ethylene and propylene, it is possible to reduce the percentage of the most flexible polymer in the mixture, and hence to reduce wall porosity, for a given targeted flexibility. Most advantageously, the first polymer is a heterophase copolymer of ethylene and propylene.

Indeed it is within this family of polypropylenes that the propylenes with the lowest flexural modulus values were found.

In Table 2, the first polymer which is the most rigid of polymers and belongs to the polypropylene family:
in solution of type no 1:
   has an indicated flexural modulus of 740 MPa, and measured at 733 MPa, of between 850 and 500 Mpa, and
in solution of type no 2:
   has an indicated flexural modulus of 470 Mpa and measured at 399 MPA, less than 500 MPa.

Analysis of Table 2 leads to ascertaining that with the material chosen in solution type no 1, after mixing and for resulting flexural modulus values of the material lying between 300 and 400 MPa, it is possible to achieve weight losses in the order of 100 to 130 and hence to obtain materials with a strong water barrier.

Similarly, with the material chosen in solution type no 2, after mixing and for resulting flexural modulus values of the material lying between 150 and 300 MPa, i.e. very flexible for a wall thickness close to 0.6 mm, it is possible to achieve weight losses of between 150 and 250 i.e. lying without reservation within the scale enabling qualification of the material for large-sized tubes.

For each solution of no 1 type (giving priority to the barrier effect) or solution of no 2 type (giving priority to wall flexibility), the first polymer was softened by means of a second polymer belonging to the polypropylene or polyethylene family.

When the option chosen for the second material is a polyethylene, preferably a linear polyethylene is chosen whose melt flow index guarantees resistance to stress-cracking, its melt flow index (MFI) lying between 3 g/10 mn and 15 g/10 mn, preferably between 4 g/10 mn and 12 g/10 mn.

When the flexural modulus of the second polymer is greater than 70 MPa, this polymer can be integrated to the proportion of 15% to 85% in the mixture, preferably 25% to 75%.

For example, in solution no 1, the mixture of 50% CLYRELL EC140P and 50% DOWLEX 2035E offers a weight loss of 101 and a flexural modulus of 360. Its coefficient of dispersion Kd is 0.26.

It is a solution with good results since it is obtained with a material whose resulting melt flow index (MFI) is approximately 10 g/10 mn, whereas an equivalent solution with the PE option uses a material whose melt flow index (MFI) is significantly lower to withstand stress-cracking.

The PP/PE option with medium flexibility therefore opens up prospects for thinning the wall, hence softening, which is of great advantage for tubes requiring a material with a strong water barrier.

When the sought solution is a very flexible polymer, the flexural modulus of the second polymer used being less than 70 MPa, it was found in accordance with the results of Table 2 that the weight loss of the cream contained in the tube increases very rapidly with the proportion of the second polymer. Therefore the percentage of said polymer in the mixture must be limited to a maximum of 50%, this percentage preferably lying between 15% and 40%.

To limit the percentage of the second polymer in the mixture to less than 50%, preferably the first polymer used is as flexible as possible.

Table 2 shows that in solution type no 2 very low flexural modulus values, between 150 and 300 MPa, cannot be obtained with acceptable weight losses, lying between 220 and 270 when the proportion of the second material in the mixture is 33%.

It is therefore a very effective option for tubes requiring a flexible material, and more particularly large size tubes requiring a thick wall, thicker than 0.6 mm for example.

Also, preferably a copolymer of ethylene-octene is used.

When the second material is a polypropylene, the rules are identical.

If the second polypropylene is very flexible, its flexural modulus being less than 70 MPa, it should be used in a proportion of less than 50%, preferably between 15% and 40%.

If the second polypropylene has average flexibility, its flexural modulus being greater than 70 MPa, it may be used in a proportion of between 15 and 85%, preferably between 25 and 75%.

The polypropylenes used as second material are advantageously copolymers of propylene and ethylene. Preferably, they are heterophase polymers.

Finally, as evidenced in Table 2, some polypropylenes have a sufficiently low flexural modulus for their use alone, without adding a second polymer.

When it is desired to use a strong barrier material, a material with relatively low flexibility is used, for example close to the upper limit of 500 MPa for a small tube of diameter 19 mm and having a wall thickness of less than 0.65 mm. In this case the first polymer is used without the addition of a second polymer.

Table 2 also shows, with solution type no 3, that some polypropylenes with a low flexural modulus, typically less than 250 MPa (indicated modulus of 220 MPa, measured modulus of 134 MPa) have acceptable weight loss for large size tubes, of a capacity of at least 30 ml.

This very effective solution for short-term weight loss tests is less effective however than solutions based on solution type no 2 mixtures with regard to long-term weight loss tests.

Another observation concerns the choice to be made between a second polymer taken from the polypropylene family or a second polymer taken from the polyethylene family, when the flexural modulus and weight loss are comparable.

The criteria of choice will then be as follows:
as first criterion the viscosity of the material, if it is desired to thin the wall, but with the reminder that the water barrier is proportional to wall thickness,
as second criterion, the feel of the material, since for two materials of equivalent flexibility, the feel of polypropylene is relatively more “tense” whilst the feel of polyethylene is relatively “softer”.

The other criteria of choice relate to the secondary barrier effects, of ester barrier type, oxygen barrier or barrier against any other component of the product contained in the cream, and to the effects of yellowing of the wall under the effect of any of the components of the product contained in the tube or under the effect of any external contaminant agent during use of the tube by the consumer.

Finally, consideration may be given to secondary effects such as crease memory or whitening of the wall in the zones undergoing deep creases, these effects being very strongly attenuated even eliminated by means of the polypropylenes characterized in the invention.

Generally, it will have been easily understood that to optimise any solution it is preferable to use materials whose characteristics are as close as possible and hence to use polymers whose flexural modulus values are as close as possible.

Also, it is advantageous only to use polypropylenes whose melt flow index is compatible with the flow pathway defined by the length and thickness of the wall, and nonetheless able to resist stress-cracking in accordance with previously defined specifications, i.e. having a melt flow index (MFI) measured in accordance with standard ISO 1133 that is less than 100 g/10 mn, preferably less than 20 g/10 mn.

Also, the tube of the invention is obtained by injecting the head and the skirt in a single operation, using extreme injection pressure conditions in order to inject materials of high viscosity into thin walls. Whereas usual injection pressures are in the order of 450 to 600 bars, it may be necessary to use high injection pressures, for example in the order of 1250 to 2500 bars to obtain a skirt that is simultaneously flexible, has a water barrier and resists stress-cracking when the material used is a polypropylene-based material.

In the invention, the relative rigidity of the first polymer may be simultaneously offset through the addition of a polymer having a greater or lesser ethylene content, hence generally less fluid, and through thinning of the wall, which assumes the use of high injection pressures, especially for large size tubes.

The tube of the invention has a wall thickness of between 0.30 and 1.00 mm at skirt mid-height for a skirt length of between 40 and 200 mm.

Since the injected materials can withstand injection pressures of 1250 to 2500 bars, it is advantageous to use these pressures to reduce the thickness of the tube wall and to increase flexibility, without reducing the flexural modulus, and hence without degradation of the barrier effect.

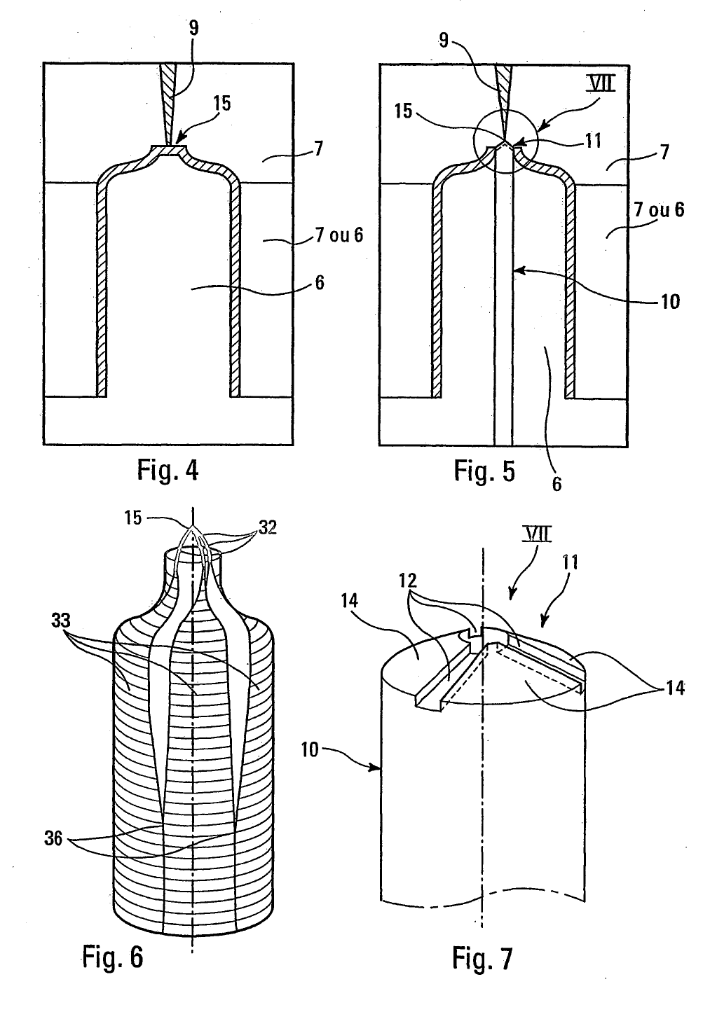

Some tubes are injected in a known mould such as shown FIG. 4, this mould consisting of a core denoted 6 and an impression denoted 7 positioned in relation to the injection nozzle 9 i.e. the channel through which the molten plastic material is led into the cavity defined by the impression and core. Under the effect of the very high injection pressure needed to inject the material into the wall thickness optimised to improve tube flexibility and for a long skirt length, the core of the mould tends to deflect towards the impression. This gives rise to a wall of variable thickness and hence of variable flexibility. More seriously, the off-centring of the core generates preferential flows of material during injection of the skirt, these preferential flows joining together as “weld lines” forming zones of non-resistance to stress-cracking.

It is therefore very important for the tube wall to be of constant thickness, without any material reinforcement especially longitudinally, to maintain both comfort of use of the tube and resistance to stress-cracking.

A first type of injection mould for obtaining this result is shown FIG. 5. As can be seen in this figure, the core 6 of this type of mould has a central part denoted 10 having a free end denoted 11 which centre bears upon the impression 7.

This centre bearing provides the desired flexibility while maintaining the water barrier property by acting on the reduced thickening of the wall, as opposed to reducing the flexural modulus of the material used. For a given material, it is found for example that the tube skirt shows substantial rigidity beyond a wall thickness of 0.8 mm, whereas flexibility is satisfactory for a wall thickness of between 0.45 mm and 0.50 mm. Therefore, the stabilisation of the core obtained through the centre bearing of its central part 10 on the impression, combined with the use of the polypropylene, makes it possible:
to reduce wall thickness down to approximately 0.45 mm for small size tubes whose wall is of average flexibility,
to reduce wall thickness down to approximately 0.50 mm for small size tubes with a very flexible wall, and
to reduce wall thickness down to 0.60 mm for large size tubes whose length, excluding the dispensing channel, is close to 150 mm.

Irrespective of tube shape, of which a non-limitative illustration is given FIGS. 1 and 2, the invention therefore applies both to tubes whose length H is between 40 and 85 mm, and more particularly to large size tubes whose length H is between 85 and 200 mm.

To proceed with injecting the material from the central point of injection 15 as far as the tube head, radial supply channels are created in the free end 11 of the central part 10 of the core. The supply channels 12 and the bearing zones 14 of the free end 11 of the central part 10 are better visible in FIG. 7 which is an enlarged view of the part denoted VII in FIG. 5.

However, the use of this technique has the drawback of creating as many skirt supply points as there are channels 12 between the injection point and the tube head.

As shown FIG. 6, three separate sheets of material 33 are created, supplied by the three flows of material 32, corresponding to the three channels 12, the sheets being joined together by three weld lines 36 and forming the tube skirt at the end of the injection operation.

Another solution consists of off-centring injection point 15, for example non-limitative fashion, by its duplication and by placing each injection point in the continuation of wall 29 parallel to axis XX′ at end 122 of the tube.

This possible but non-preferred solution, highly complicates the mould injection system, risks deteriorating resistance to stress-cracking of the weld lines, but makes it possible to eliminate the supply channels 12 while maintaining the centre bearing 11 of the core on the impression.

The weld lines 36 have the disadvantage of creating skirt zones having non-resistance to stress-cracking, this disadvantage being attenuated through the use of polypropylene which is more resistant than polyethylene to stress-cracking.

To overcome this drawback, the invention specifies the shape details of the tube and corresponding methods which make it possible to attenuate the weld lines while maintaining the essential bearing of the core on the impression.

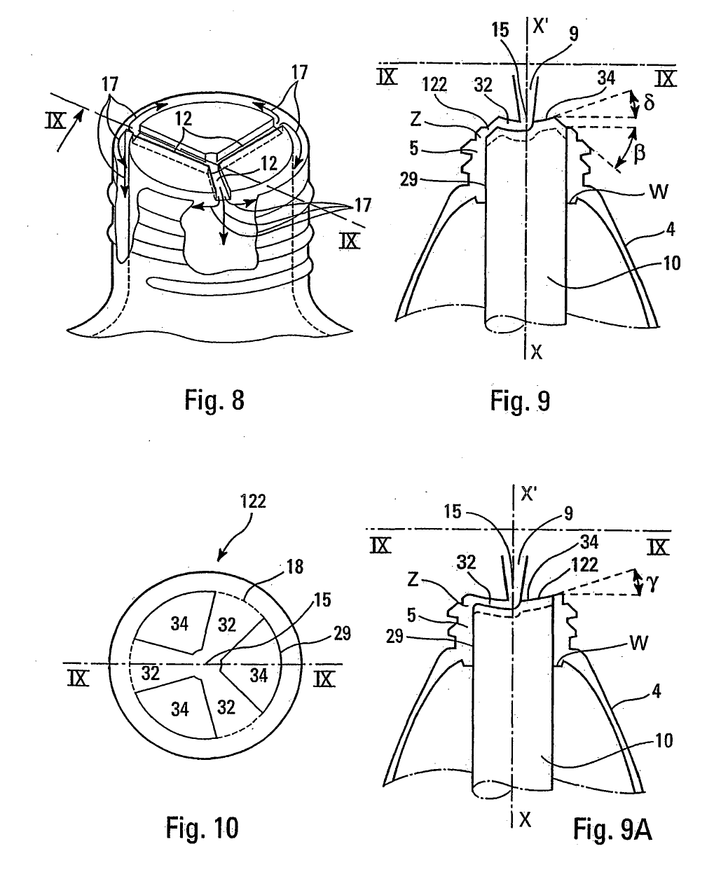

The shape details of the tube and corresponding mould are now described with reference to FIGS. 8, 9, 9A and 10.

End 122 of the tube is at least formed of sectors 32 corresponding to channels 12 made in the free end 11 of the central part 10 of the core, in accordance with FIG. 10.

Firstly, in order to facilitate the reconstitution of a circular flow of material from the joining points between the radial injection channels and the upper part of the head, it is of advantage to form a joining line that is as wide as possible between each radial injection channel and the upper part of the tube head in accordance with FIG. 10.

One advantageous solution consists of providing accumulated joining widths for sectors 32 at the joining point 18 with face 29 parallel to axis XX′ of orifice 3, which represent at least 15% of the perimeter of face 29.

Another solution further improving circular supply, but reducing the bearing surface of the core on the impression, consists of increasing the accumulated joining widths of the supply sectors at the joining point 18 with face 29 to more than 25% of the perimeter of the wall.

In order to preserve a maximum bearing surface of the core on the impression while maximizing the accumulated joining widths of sectors 32 with face 29, it is advantageous to give sectors 32 an increasing width from the injection point 15 to the joining point 15 with face 29.

Also, still in order to promote the reconstitution of a circular flow of matter, it is advantageous to provide an annular throttle zone Z located on the wall of the orifice, beyond the joining zone of sectors 32.

Finally, to further increase the effect of circular distribution, it is advantageous to extend the wall of the orifice by a ring of material W located in a plane perpendicular to axis XX′, under the end 123 of the neck.

After injection of the tube skirt and head, since the central part 10 of the core is in centre bearing upon impression 7, it will be easily understood that the wall of end 122 of the tube, projected onto a plane perpendicular to axis XX′, consists of sectors 32 corresponding to the supply channels 12 shown FIG. 8.

Wall 122 therefore has gaps in sectors 34 which correspond to bearing zones 14 of the free end 11 of the central part 10 on the impression 7.

It is possible to make the central part 10 of core 6 mobile with respect to the peripheral core and to form the apex wall 122 of the tube without any gaps by drawing backwards the mobile central part 6 of the core over a distance corresponding to the desired thickness of this apex wall.

In a first version illustrated FIG. 9, the free end 11 of the central part 10 of the core is designed in the shape of a sunken cone, the angle □ formed by the bearing surface of the free end 11 of central part 10 on impression 7 with the plane perpendicular to the longitudinal axis XX′ of the tube being less than 45°, preferably between 15° and 20° to offer optimum user comfort.

This version is adapted for tubes of small size. It is more difficult to implement for large size tubes. For tubes of large size the length of the central part 10 of the core and the types of steel chosen are such that the central core is compressed under the injection pressure of between 1200 and 2500 bars so that centring cannot be ensured with a bearing slope of between 15° and 20°, a bearing slope of between 35° and 45° being required to offset core compression.

In a second version illustrated FIG. 9A, and applicable to large size tubes, the free end 11 of the central part 10 is in the shape of a projecting cone frustum, the angle □ formed by the bearing surface of the projecting cone frustum on impression 7 with the plane perpendicular to longitudinal axis XX′ of the tube lying between 35° and 45°.

In this same version, the free end 11 of the central part 10 is in the shape of a sunken cone in its part internal to the projecting cone frustum, the angle □ formed by the bearing surface of the sunken cone of free end 11 of central part 10 on impression 7 with the plane perpendicular to longitudinal axis XX′ of the tube being less than 45°, preferably between 15° and 20°.

After retraction of the central core, the wall 122 is in the shape of a projecting cone frustum in its peripheral part and cup-shaped in its central part.

Therefore in this second version, the shape given to end 122 of the tube makes it possible simultaneously to optimise centring of the core during the injection operation and to offer optimal user comfort.

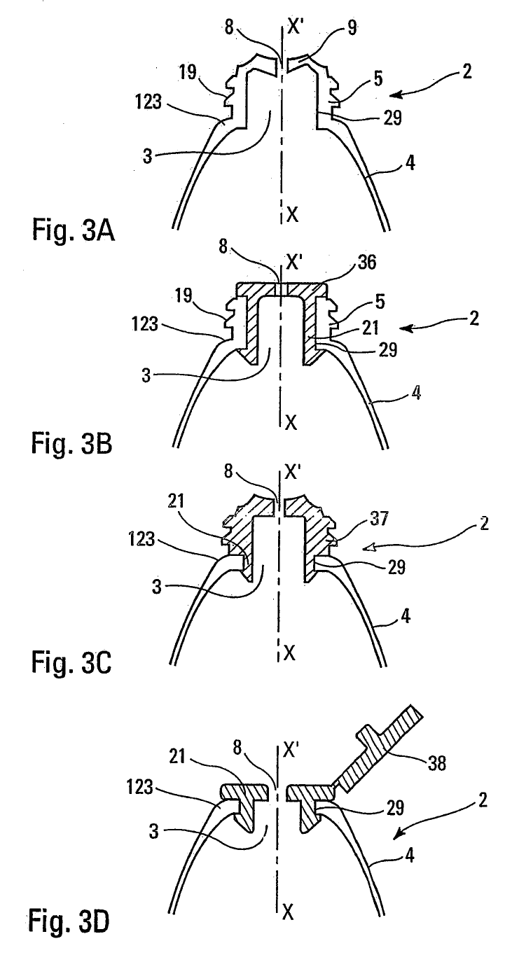

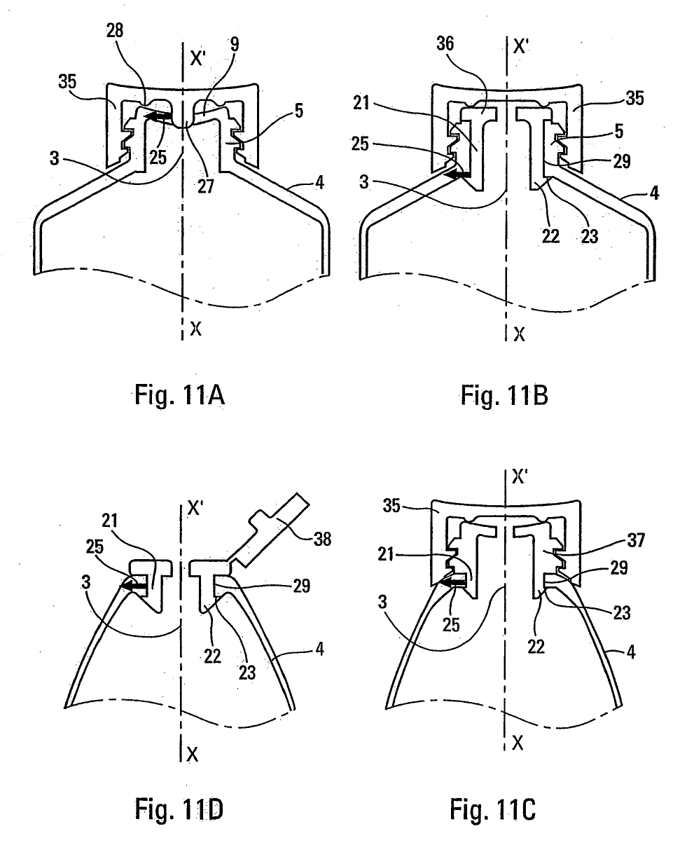

In this first version, (FIG. 11A) and this second version (FIG. 3A) the tube head comprises a single-piece securing means of nozzle type 5 and a single-piece reducer 9, the nozzle and the reducer being positioned in the continuation of orifice 3 on axis XX′, the apex wall 122 of the tube forming the reducer 9, the orifice 8 of the reducer being obtained by cutting after forming the tube by injection, the tube, nozzle and reducer thereby forming a single-piece assembly formed by injection in a single operation.

Finally, the tube usually being closed by capping means 35 of “service” cap type or “standard” cap type, a first solution consists of connecting the tube and cap by means of a screw assembly for example.

The single-piece tube head being made in the same flexible, elastic material as the skirt, the constituent material of the head and in particular the screw pitch may creep under the effect of the force resulting from tightening of the cap onto the tube.

To overcome this shortcoming, two arrangements are preferred in accordance with the drawing in FIG. 11A.

Firstly the screw thread 19 is a thread of asymmetric type in accordance with the drawings in FIGS. 3A, 9 and 9A.

Secondly, imperviousness is ensured by means of a tip 27 of conical shape arranged on the capping means 35, the seal being ensured by placing the wall of the single-piece reducer 9 under centrifugal radial tension 25 when tip 27 enters the opening orifice 8 of the reducer as shown FIG. 11A.

In this preferred solution the bearing of the capping means on the tube is ensured by means of a bearing ring 28 located on the inner periphery of cap 35 and bearing on the peripheral zone of the reducer.

In a third version, the head comprises single-piece securing means of nozzle type 5 positioned in the continuation of orifice 3 on axis XX′, the tube and the securing means 5 forming a single-piece assembly made in a single injection operation as shown FIG. 3B, the head optionally being fitted with an added accessory of added reducer type or nozzle tip.

In a fourth version, the head is fitted with an added accessory of dispensing-means type of added reducer type or added nozzle tip or other, securing means of screw nozzle type or other, capping means of service cap type or other as shown in non-limitative fashion in FIGS. 3C and 3D.

In either one of these versions, the head is fitted with the added accessory forming an added reducer 36, added nozzle forming a reducer 37, service cap 38, the added accessory being positioned in the continuation of orifice 3 on axis XX′, the accessories 36, 37 and 38 forming non-limitative examples.

When the head is fitted with an added accessory 36, 37 or 38, the invention preferably provides that the accessory is equipped with a chimney 21 whose outer face is conjugated with the face 29 parallel to axis XX′ of orifice 3, after inserting the chimney 21 inside orifice 3 to ensure securing of the accessory on the tube, the chimney placing the wall 29 of the orifice under centrifugal radial tension 25.

Since the wall of the tube of the invention is made in a flexible material, the described solution makes it possible to avoid a gaping or more seriously a faulty seal or disassembly of the tube from the added accessory when the consumer presses on the wall of the tube. In addition, the proposed solution takes advantage of the flexibility of the material of the invention to ensure the resistance of the accessory.

Preferably, the chimney 21 is fitted with a device of conical shape 22 to ensure its insertion into orifice 3.

Further preferably, the outer face of the chimney 21 is radially recessed 23 from the device 22, the counter-back taper 23 locking the added accessory in axis XX′, the added accessory then being non-removable.

In either of these versions 3 and 4, the tube and the added accessory have conjugate means to ensure the imperviousness of the assembly and optionally to prevent rotation of the added accessory with respect to the tube.

1-36. (canceled)

37. A tube resistant to stress-cracking and forming a water barrier comprising a flexible skirt elongate in an axial direction and a head comprising at least one evacuation orifice and a neck forming a radial extension of the at least one evacuation orifice and being joined to the skirt along the axial direction, at least the skirt and the neck forming a single-piece assembly, a wall of the tube consisting of a mixture of a number “n”, where n is at least equal to 1 of polymers belong to the family of copolymers-olefins prepared from C₂ to C₁₀ monomers, the wall at a mid-distance of its length along the axial direction from an end of the skirt distant from the head as far as an end of the neck forming the at least one evacuation orifice and having a wall thickness of between 0.30 and 1.00 mm, at least one polymer of the mixture belongs to the polypropylene family, the constituent mixture of the tube wall having a flexural modulus of between 700 MPa and 80 MPa, according to standard NF EN ISO 178, and each polymer having a flexural modulus defined according to standard NF EN ISO 178 and being conventionally assigned a rank “i” which, in a classification of the “n” polymers of the mixture in decreasing order of their respective flexural modulus values μᵢ, places the polymer between a first polymer (i=1) of maximum rigidity and a last polymer (i=n) of minimum rigidity, and each polymer being contained in the mixture in a weight percentage xᵢ with respect to the total weight of the mixture, the mixture has a dispersion factor (Kd) of the flexural modulus values of no more than 3 or 2.2 according to whether or not it contains a polyethylene, preferably no more than 2 in both these cases, and further preferably no more than 1.5, this dispersion factor (Kd) being defined as:
$$Kd = {\sum }_{i = 1}^{n} [ ( ( {\sum }_{j = 1}^{i - 1} {x}_{j} ) \cdot {( {ν}_{1 , i - 1} - {ν}_{1 , i} )}^{2} + {x}_{i} \cdot {( {λ}_{i} - {ν}_{1 , i} )}^{2} ) / {ν}_{1 , i}^{2} ] ,$$
in which:
λᵢ=MAX(μᵢ,1500 MPa)
and in which:
$${ν}_{p , q} = ( {\sum }_{i = p}^{q} {x}_{i} \cdot {λ}_{i} ) / ( {\sum }_{i = p}^{q} {x}_{i} ) .$$

38. The tube according to claim 37, wherein the flexural modulus is in the range of from 500 MPa to 120 MPa.

39. The tube as in claim 37, wherein the first polymer is a copolymer of propylene and ethylene.

40. The tube as in claim 37, wherein the first polymer is a heterophase polypropylene copolymer of propylene and ethylene.

41. The tube as in claim 37, wherein the most rigid polymer has a flexural modulus of no more than 850 MPa, with the result that the mixture forming the tube wall has a strong water barrier.

42. The tube as in claim 37, wherein the first polymer has a flexural modulus of no more than 500 MPa.

43. The tube as in claim 37, wherein the mixture comprises at least one second polymer.

44. The tube as in claim 43, wherein the at least one second polymer has a flexural modulus greater than 70 MPa, and in that the second polymer is contained in the mixture to a proportion of 15% to 85%.

45. The tube as in claim 44, wherein the at least one second polymer has a flexural modulus between 25% and 75%.

46. The tube as in claim 43, wherein the at least one second polymer has a flexural modulus of less than 70 MPa, and is contained in the mixture to a proportion of less than 50%.

47. The tube as in claim 46, wherein the at least one second polymer is contained in the mixture in a proportion between 15% and 40%.

48. The tube as in claim 43, wherein the at least one second polymer is a linear C₄-C₁₀ copolymer of ethylene-olefin, having a melt flow index (MFI) measured according to standard ISO 1133 of between 3 g/10 mn and 15 g/10 mn.

49. The tube as in claim 48, wherein the melt flow index is between 4 g/10 mn and 12 g/10 mn.

50. The tube as in claim 43, wherein the at least one second polymer is a copolymer of ethylene-octene.

51. The tube as in claim 43, wherein the at least one second polymer is a polypropylene.

52. The tube as in claim 43, wherein the at least one second polymer is a heterophase copolymer of propylene and ethylene.

53. The tube as in claim 37, wherein the first, and optionally the single, polymer has a flexural modulus of less than 250 MPa for a tube capacity of at least 30 ml.

54. The tube as in claim 37, wherein any polymer of the polypropylene family entering into the wall composition mixture has a melt flow index (MFI) measured according to standard ISO 1133 of no more than 100 g/10 mn.

55. The tube as in claim 54, wherein the melt flow index is no more than 20 g/10 mn.

56. The tube as in claim 37, wherein the length is between 40 and 85 mm.

57. The tube as in claim 37, wherein the length is between 85 and 200 mm.

58. The tube as in claim 37, wherein the tube is obtained by injection into an injection mould comprising a core and an impression with the core itself comprising a central part of which one free end center bears upon the impression at least during an injection phase of the tube skirt.

59. The tube as in claim 58, wherein the free end of the central part of the core comprises supply channels at an injection end which has an apex wall formed at least in part of sectors corresponding to the supply channels.

60. The tube as in claim 59, wherein accumulated widths of the sectors in zones where they join with a face parallel to the axial direction of the at least one evacuation orifice represent at least 15% of the perimeter of the face.

61. The tube as in claim 60, wherein the accumulated widths represent more than 25% of the perimeter of the face.

62. The tube as in claim 60, wherein the sectors have a width which increases from an injection point of the mould along a centrifugal radial direction as far as the joining points of the sectors with the face of the at least one evacuation orifice.

63. The tube as in claim 59, wherein the wall of the at least one evacuation orifice has an annular throttle zone located beyond the sectors.

64. The tube as in claim 58, wherein the wall of the at least one evacuation orifice is extended by a ring of material positioned in a plane perpendicular to the axial direction under the end of the neck.

65. The tube as in claim 58, wherein the central part of the core of the injection mould is mobile, and wherein an apex wall of the tube end is formed with no gaps by drawing backwardly the mobile central part over a distance corresponding to a desired thickness of the apex wall.

66. The tube as in claim 65, wherein the free end of the central part of the core is in the shape of a sunken cone, and the angle (□) formed by the bearing surface of the free end on the impression with a plane perpendicular to a longitudinal axis of the tube lies between 15° and 45°.

67. The tube as in claim 66, wherein the angle (□) lies between 15° and 20°.

68. The tube as in claim 58, wherein the free end of the central part of the core is in the shape of a projecting cone frustum, and the angle (□) formed by a bearing surface of the projecting cone frustum of the free end on the impression with a plane perpendicular to a longitudinal axis of the tube lies between 35° and 45°.

69. The tube as in claim 68, wherein the free end of the central part of the core is in the shape of a sunken cone in its part internal to the projecting cone frustum, and an angle (□) formed by the bearing surface of the sunken cone of the free end on the impression with the plane perpendicular to the longitudinal axis of the tube being less than 45°.

70. The tube as in claim 69, wherein the angle (δ) is between 15° and 20°.

71. The tube as in claim 58, wherein the head comprises a single-piece securing means of a nozzle and a single-piece reducer, wherein the nozzle and the reducer are positioned in a continuation of the at least one evacuation orifice along the axial direction, wherein the apex wall of the nozzle forms the reducer, wherein the reducer orifice is obtained by cutting after injection-forming the tube, and wherein the tube, nozzle and reducer thereby form a single-piece assembly formed by injection in a single operation.

72. The tube as in claim 71, wherein the tube is provided with capping means provided with a tip of conical shape, the tip enters into the orifice of the single-piece reducer, and the tip places the wall of the reducer under centrifugal radial tension in the vicinity of the opening orifice.

73. The tube as in claim 58, wherein the head comprises a single-piece securing means of nozzle type positioned in a continuation of the at least one evacuation orifice along the axial direction, and wherein the tube and the securing means form a single-piece assembly formed by injection in a single operation.

74. The tube as in claim 73, wherein the wall of the single-piece nozzle carries an asymmetric thread.

75. The tube as in claim 71, wherein the wall of the single-piece nozzle carries an asymmetric thread.

76. The tube as in claim 37, further comprising an added accessory of dispensing type of added reducer type or added nozzle tip type, or securing means of added nozzle type forming a reducer or nozzle tip, or capping means of service cap type, and the added accessory being positioned in a continuation of the at least one evacuation orifice along the axial direction.

77. The tube as in claim 76, wherein the added accessory is provided with a chimney of which an outer face is conjugated with a face parallel to the axial direction of the at least one evacuation orifice after inserting the chimney inside the orifice.

78. The tube as in claim 77, wherein the chimney of the added accessory places the wall of the at least one evacuation orifice under centrifugal radial tension.

79. The tube as in claim 77, wherein the added accessory is non-removable and the chimney of the added accessory is fitted with a penetration device of conical shape, the outer face of the chimney being radially recessed with respect to the penetration device.

80. A method for fabricating a flexible tube consisting of a skirt and head comprising at least one evacuation orifice and a neck forming a radial extension of the at least one evacuation orifice and being joined to the skirt, at least the skirt and the neck forming a single-piece assembly resistant to stress-cracking and forming a water barrier, the method comprising the steps of:
using as constituent material of a wall of the tube a mixture of a number “n”, where n is at least equal to 1, of polymers belonging to the family of copolymers-olefins prepared from C₂ to C₁₀ monomers, at least one polymer belonging to the polypropylene family, the constituent mixture of the wall having a flexural modulus of between 700 and 80 MPa according to standard NF EN ISO 178; and
fabricating the skirt and head of the tube by injecting the mixture, in a single injection operation, into an injection mould comprising an impression and a core comprising a central part of which one free upper end center bears upon the impression at least during the skirt injection phase.

81. The method as in claim 80, wherein the using step comprises using a constituent mixture having a flexural modulus of between 500 and 120 MPa according to said standard.
